(19) United States
(12) Patent Application Publication
(10) Pub. No.: US 2022/0207615 A1
(43) Pub. Date: Jun. 30, 2022

(54) Blockchain Insurance Verification System

(71) Applicant: Injala, Inc., Irving, TX (US)

(72) Inventor: Hyder Naqvi, Irving, TX (US)

(21) Appl. No.: 17/133,766

(22) Filed: Dec. 24, 2020

(51) Int. Cl. G06Q 40/08; G06F 16/27; G06F 16/242

(52) U.S. Cl. CPC G06Q 40/08; G06F 16/242; G06F 16/27

(57) ABSTRACT

A blockchain insurance verification system obtains information for one or more policies and/or updates to such policies related to one or more insureds and stores such information in one or more blockchains. The information may detail the risk that is covered, the limits of the coverage, conditions of the coverage, endorsements and/or exclusions to the coverage, and so on. The information may also include an indication of an authentication strength level, which may correspond to the entity who provided the information and/or verified the accuracy of the information. The system may be usable to store such information in an unalterable but updatable way, provide such information, connect one or more parties looking to provide and/or obtain such information, verify such information, determine an authentication strength level of such information, determine one or more sets of requirements, compare such information to one or more sets of requirements, provide notifications, and so on.

### FIELD

The described embodiments relate generally to insurance verification systems. More particularly, the present embodiments relate to blockchain insurance verification systems.

### BACKGROUND

Insurance is a practice or arrangement by which an entity (i.e., the insurer) provides a guarantee of compensation to another (i.e., the insured) for a specified loss, damage, illness, death, or other risk in return for payment of a premium. Types of insurance include personal automobile insurance, commercial automobile insurance, liability insurance, commercial liability insurance, professional liability insurance, property insurance, health insurance, flood insurance, life insurance, mortgage insurance, workers' compensation insurance, agricultural insurance, and so on. Insurance policies may specify the risk that is covered, the limits of the coverage, conditions of the coverage, endorsements and/or exclusions to the coverage, and so on.

People or other entities may depend on insurance obtained by other people or entities. For example, a company may hire a contractor or vendor to do work on a property and may depend on that contractor or vendor to be insured against the risk that damage occurs to the property, to other property, to the contractor or vendor and/or the contractor's or vendor's employees and/or other people, and so on. This dependency may enable the company to transfer the risk to cover their liabilities from the contractor's or vendor's negligence while performing their activities. As such, the company may verify the insurance policy and/or policies of the contractor or vendor to determine that the appropriate coverage and/or coverages are in place.

### SUMMARY

The present disclosure relates to a blockchain insurance verification system. The system may obtain information for one or more policies and/or updates to such policies related to one or more insureds and/or store such information in one or more blockchains. The information may detail the risk that is covered, the limits of the coverage, conditions of the coverage, endorsements and/or exclusions to the coverage, and so on. The information may also include an indication of an authentication strength level, which may correspond to the entity (such as the insured, the requester, an insurance agent, the insurer, and so on) who provided the information and/or verified the accuracy of the information. The system may be usable to store such information in an unalterable but updatable way, provide such information (which may be admissible in court and/or other proceedings due to the unalterable nature of previously stored information), connect one or more parties looking to provide and/or obtain such information, verify such information (which may be performed in real time), determine an authentication strength level of such information, determine one or more sets of requirements, compare such information to one or more sets of requirements, provide notifications (such as regarding coverage, lack of coverage, coverage to obtain, changes in coverage, coverage endorsements and/or exclusions, changes to information that an entity has verified, and so on), submit one or more claims related to the information, obtain payment and/or subrogation related to one or more submitted claims, provide the information, provide results of a comparison of the information to one or more sets of requirements, communicate with one or more systems to perform these functions, and so on.

In various embodiments, an insurance verification system includes at least one non-transitory storage medium that stores instructions and at least one processor. The at least one processor executes the instructions to store information for at least one insurance policy in at least one block of a blockchain, determine an authentication strength level of the information according to an entity who provided the information or endorsed the information as accurate, and store an indication of the authentication strength level in association with the at least one block.

In some examples, the at least one processor determines that the authentication strength level is a lowest authentication strength level when the entity is other than a licensed insurance agent or an insurer. In a number of examples, the at least one processor determines that the authentication strength level is a higher authentication strength level when the entity is a licensed insurance agent unassociated with the at least one insurance policy than when the entity is other than the licensed insurance agent or an insurer. In various examples, the at least one processor determines that the authentication strength level is a higher authentication strength level when the entity is a licensed insurance agent associated with the at least one insurance policy than when the entity is other than the licensed insurance agent associated with the at least one insurance policy or an insurer. In some examples, the at least one processor determines that the authentication strength level is a highest authentication strength level when the entity is an insurer.

In a number of examples, the at least one processor receives a claim associated with the at least one insurance policy and processes the claim. In various implementations of such examples, the at least one processor compares the authentication strength level to a threshold; when the authentication strength level is above the threshold, pays the claim prior to submitting the claim to an insurer associated with the at least one insurance policy for payment; and otherwise, obtains payment for the claim from the insurer prior to paying the claim.

In some embodiments, an insurance verification system includes at least one non-transitory storage medium that stores instructions and at least one processor. The at least one processor executes the instructions to determine a set of requirements associated with a requester, generate a comparison of the set of requirements to information for at least one insurance policy associated with an insured that is stored in at least one block of a blockchain, and provide results of the comparison.

In various examples, the results indicate that the at least one insurance policy satisfies the set of requirements. In a number of examples, the results indicate coverage required by the set of requirements that is missing from the at least one insurance policy. In some implementations of such examples, the results are provided as a prompt to obtain the coverage.

In a number of examples, the results indicate that an authentication strength level of the information required by the set of requirements is satisfied. In various examples, the results prompt an entity to endorse the information as accurate in order for an authentication strength level of the information required by the set of requirements to be satisfied. In some examples, the at least one processor determines that a change affects the results, generates an updated comparison of the set of requirements to the information, and provides results of the updated comparison.

In a number of embodiments, an insurance verification system includes at least one non-transitory storage medium that stores instructions and at least one processor. The at least one processor executes the instructions to store information for at least one insurance policy associated with an insured in at least one block of a blockchain wherein the information is associated with an authentication strength level, associate the information with a set of requirements for a requester, determine a change to the information or the set of requirements, and provide a notification of the change.

In some examples, the notification indicates that the information no longer satisfies the set of requirements. In various examples, the notification alerts an entity who endorsed the information as accurate that the information has changed. In a number of examples, the notification prompts the insured to obtain additional insurance coverage.

In various examples, the change corresponds to a reduction in coverage associated with the at least one insurance policy. In some examples, the change corresponds to a changed beneficiary associated with the at least one insurance policy.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a first example insurance verification system.

FIG. 2 depicts a second example insurance verification system.

FIG. 3 depicts a third example insurance verification system.

FIG. 4 depicts a fourth example insurance verification system.

FIG. 5 depicts a fifth example insurance verification system.

FIG. 6 depicts a sixth example insurance verification system.

FIG. 7 depicts an example implementations of a verification system that may be used in one or more of the systems of FIGS. 2-6.

FIG. 8 depicts a flow chart illustrating a first example method for operating an insurance verification system. This method may be performed by one or more of the systems of FIGS. 2-7.

FIG. 9 depicts a first example process for determining an authentication strength level. This process may be used in one or more of the systems of FIGS. 2-6 and 7 and/or the method of FIG. 8.

FIG. 10A depicts a second example process for determining an authentication strength level. This process may be used in one or more of the systems of FIGS. 2-6 and 7 and/or the method of FIG. 8.

FIG. 10B depicts a third example process for determining an authentication strength level. This process may be used in one or more of the systems of FIGS. 2-6 and 7 and/or the method of FIG. 8.

FIG. 11 depicts a fourth example process for determining an authentication strength level. This process may be used in one or more of the systems of FIGS. 2-6 and 7 and/or the method of FIG. 8.

FIG. 12A depicts a fifth example process for determining an authentication strength level. This process may be used in one or more of the systems of FIGS. 2-6 and 7 and/or the method of FIG. 8.

FIG. 12B depicts a sixth example process for determining an authentication strength level. This process may be used in one or more of the systems of FIGS. 2-6 and 7 and/or the method of FIG. 8.

FIG. 12C depicts a seventh example process for determining an authentication strength level. This process may be used in one or more of the systems of FIGS. 2-6 and 7 and/or the method of FIG. 8.

FIG. 12D depicts an eighth example process for determining an authentication strength level. This process may be used in one or more of the systems of FIGS. 2-6 and 7 and/or the method of FIG. 8.

FIG. 13 depicts a ninth example process for determining an authentication strength level. This process may be used in one or more of the systems of FIGS. 2-6 and 7 and/or the method of FIG. 8.

FIG. 14 depicts a flow chart illustrating a second example method for operating an insurance verification system. This method may be performed by one or more of the systems of FIGS. 2-7.

FIG. 15 depicts a flow chart illustrating a third example method for operating an insurance verification system. This method may be performed by one or more of the systems of FIGS. 2-7.

FIG. 16 depicts a flow chart illustrating a fourth example method for operating an insurance verification system. This method may be performed by one or more of the systems of FIGS. 2-7.

FIG. 17 depicts a flow chart illustrating a fifth example method for operating an insurance verification system. This method may be performed by one or more of the systems of FIGS. 2-7.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

People and/or other entities may find it challenging to verify coverage provided by an insurance policy and/or policies obtained by other people and/or entities. This may be due to a number of factors, such as privacy arrangements, inability to access records, inability to verify information and/or currency of information, lack of systems for performing these functions, and so on.

Typically, a requester may request insurance policy information for an insured. The requester may request the information from the insured, who may obtain the information and/or some kind of proof of coverage from their insurer and/or insurance agent and provide such to the requester and/or instruct their insurer and/or insurance agent to do so. However, such an arrangement may be inefficient, slow, inaccurate, subject to forgery and/or fraud, provide incomplete information, provide results that are not admissible in court and/or other proceedings, require manual matching up of coverage to a set of requirements for which the requester desires coverage, and so on. A blockchain insurance verification system as illustrated and described in the present application may overcome these issues.

Generally, blockchains are decentralized and distributed databases or digital ledgers that may be used to record transactions across one or more computers. A blockchain typically includes a list of records, referred to as “blocks,” that may be linked and secured using cryptography. Each block may include a cryptographic hash of the previous block, a timestamp, and transaction data. The blockchain may be managed by a peer-to-peer network collectively adhering to a protocol for inter-node communication and validation of new blocks.

Each node in the network may store a complete copy of the entire blockchain. When a transaction is submitted, nodes of the network may come to a consensus according to the protocol regarding whether or not to validate the transaction. If so, the validated transaction may be added to the blockchain as a new block and propagated to storage throughout the network. Once recorded, data in a block may be unable to be altered retroactively without alteration of all subsequent blocks, which may require collusion of a network majority. Thus, the decentralization and consensus may provide high fault tolerance and resistance to unauthorized modification. This may allow participants in the blockchain network to verify and audit transactions inexpensively and reliably.

Some blockchain networks have a group of nodes where a portion of the group is designated as voting nodes. The voting nodes may be the nodes that are used to process and approve transactions whereas other nodes perform functions other than processing transactions. For example, hyperledger fabric blockchain networks use voting nodes and read nodes. The voting nodes process transactions by arriving at a consensus and updating the blockchain. By contrast, read nodes may only store a copy of the blockchain.

The present disclosure relates to a blockchain insurance verification system which may overcome these issues. The system may obtain information for one or more policies and/or updates to such policies related to one or more insureds and/or store such information in one or more blockchains. The information may detail the risk that is covered, the limits of the coverage, conditions of the coverage, endorsements and/or exclusions to the coverage, and so on. The information may also include an indication of an authentication strength level, which may correspond to the entity (such as the insured, the requester, an insurance agent, the insurer, and so on) who provided the information and/or verified the accuracy of the information. The system may be usable to store such information in an unalterable but updatable way, provide such information (which may be admissible in court and/or other proceedings due to the unalterable nature of previously stored information), connect one or more parties looking to provide and/or obtain such information, verify such information (which may be performed in real time), determine an authentication strength level of such information, determine one or more sets of requirements, compare such information to one or more sets of requirements, provide notifications (such as regarding coverage, lack of coverage, coverage to obtain, changes in coverage, coverage endorsements and/or exclusions, changes to information that an entity has verified, prompts to review and/or endorse provided information, and so on), submit one or more claims related to the information, obtain payment and/or subrogation related to one or more submitted claims, provide the information, provide results of a comparison of the information to one or more sets of requirements, communicate with one or more systems to perform these functions, and so on.

In this way, the system may be able to perform a variety of functions related to insurance verification that are not performable by previous systems and that the system would not previously have been able to perform absent the technology disclosed herein. The system may eliminate and/or reduce communications used to obtain, verify, and/or provide information related to coverage; control the obtaining, verification, and/or providing of the information related to coverage; and so on. This may enable the system to operate more efficiently and/or quickly perform functions related to insurance verification while consuming fewer hardware and/or software resources as more resource consuming techniques may be omitted. Further, the system may eliminate and/or reduce unnecessary hardware and/or software components and/or provide greater flexibility, accuracy, and/or functionality over previous techniques.

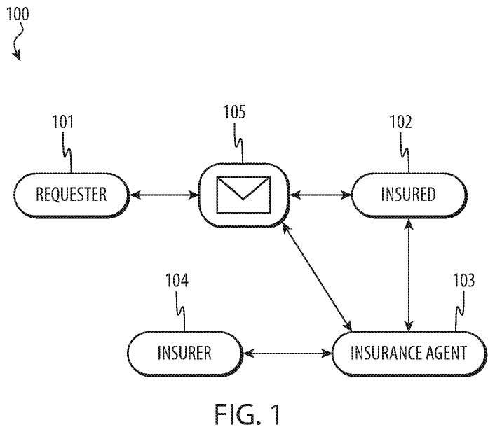

These and other embodiments are discussed below with reference to FIGS. 1-17. However, those skilled in the art will readily appreciate that the detailed description given herein with respect to these Figures is for explanatory purposes only and should not be construed as limiting.

FIG. 1 depicts a first example insurance verification system 100. The system 100 may include one or more requesters 101, insureds 102, insurance agents 103, and/or insurers 104. The requesters 101, insureds 102, and/or insurance agents 103 may send and/or receive one or more communications 105 relating to requests for insurance policy information and/or one or more kinds of proof of coverage.

By way of illustration, the communications 105 may be one or more emails. The requester 101 may email the insured requesting insurance policy information. The insured 102 may receive the email, email their insurance agent 103 to obtain proof of coverage (who may obtain the proof of coverage from the insurer 104), receive an email in response from their insurance agent 103 with the proof of coverage, and send an email to the requester 101 providing the proof of coverage. Alternatively, the insured 102 may request their insurance agent 103 email the proof of coverage directly to the requester 101.

Regardless, email and/or similar communication technologies may be unreliable, slow, inefficient, unsecure, dependent upon human operators, redundant, vulnerable to spoofing and/or other fraud and/or forgery, and so on. Additionally, the proof of coverage may be in a form that also has issues.

For example, the proof of coverage may be an Acord form (such as an Acord 25 form), portable document format file, and/or other file. Such an Acord form may list the insurer, the insured, the types of coverage (such as commercial general liability, automobile liability, umbrella liability, workers' compensation, professional liability, and so on), the limits of coverage (such as the coverage limits for each occurrence, for damage to premises, personal injury, medical expenses, aggregate, products, bodily injury, property damage, uninsured motorist coverage, underinsured motorist coverage, and so on), and so on. However, such an Acord form may provide incomplete information. For example, Acord forms may not include any information related to endorsements, exclusions, or similar modifications to coverage related to an insurance policy. For example, an endorsement or exclusion may specify that coverage only applies to installation of carpeting, or that coverage is excluded for pollution damage. As the Acord form may not indicate these coverage modifications, the Acord form may provide an inaccurate understanding of available coverage. For example, a requester 101 may obtain an Acord form for an insured 102 showing $100,000 coverage for general liability and hire the insured 102 to install a roof, only to find out later that an endorsement limited coverage for general liability to carpet installation and/or an exclusion excluded coverage for roofing.

As such, the system 100 of FIG. 1 may have a number of issues. Such issues may be overcome using a blockchain insurance verification system. Examples of such systems are described below.

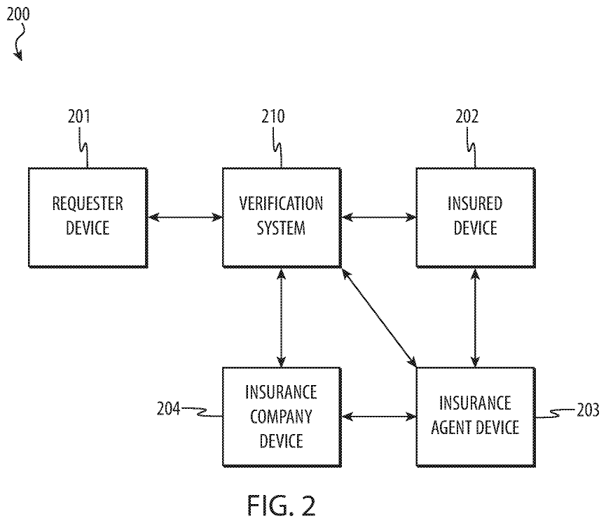

FIG. 2 depicts a second example insurance verification system 200. The system 200 may be a blockchain insurance verification system. The system 200 may include one or more verification systems 210 that are operable to communicate with one or more requester devices 201, one or more insured devices 202, and/or one or more insurance agent devices 203, such as via one or more wired and/or wireless communication networks. In some examples, the verification system 210 and/or the insurance agent devices 203 may be operable to communicate with one or more insurer devices 204.

The verification system 210 may obtain information for one or more insurance policies and/or updates to such insurance policies related to one or more insureds (which may include any information related to such insurance policies, such as types of coverage, coverage limits, endorsements, exclusions, beneficiaries and/or other parties associated with the insurance policies, whether the insurance policies are primary or dependent on a primary policy, and so on), store such information in one or more blockchains, and/or enable sharing of such information (such as by providing one or more hashes and/or other keys or mechanisms that link to such in order to facilitate access to one or more blocks). The verification system 210 may receive the information from one or more of the requester device 201, the insured device 202, the insurance agent device 203, the insurer device 204, and/or one or more other devices. The information may detail the risk that is covered relating to one or more insurance policies, the limits of the coverage, conditions of the coverage, endorsements and/or exclusions to the coverage, and so on. The information may also include an indication of an authentication strength level (which may be an indication of the determined authenticity of the information), which may correspond to the entity (such as the insured, the requester, an insurance agent, the insurer, and so on) who provided the information and/or verified the accuracy of the information (i.e., endorsed the record to verify that the record is a true record). The verification system 210 may be usable to store such information in an unalterable but updatable way, provide such information (which may be admissible in court and/or other proceedings due to the unalterable nature of previously stored information), connect one or more parties looking to provide and/or obtain such information, verify such information (which may be performed in real time), determine an authentication strength level of such information, determine one or more sets of requirements, compare such information to one or more sets of requirements (or generate such a comparison), provide notifications (such as regarding coverage, lack of coverage, whether a particular party is listed as a beneficiary, whether the insurance policy is primary or secondary, coverage to obtain, changes in coverage, coverage endorsements and/or exclusions, changes to information that an entity has verified, and so on), submit one or more claims related to the information, obtain payment and/or subrogation related to one or more submitted claims, provide the information, provide results of a comparison of the information to one or more sets of requirements, communicate with one or more systems to perform these functions, and so on.

In this way, the system 200 may be able to perform a variety of functions related to insurance verification that are not performable by previous systems and that the system would not previously have been able to perform absent the technology disclosed herein. The system 200 may eliminate and/or reduce communications used to obtain, verify, and/or provide information related to coverage; control the obtaining, verification, and/or providing of the information related to coverage; and so on. This may enable the system 200 to operate more efficiently to perform functions related to insurance verification while consuming fewer hardware and/or software resources as more resource consuming techniques may be omitted. Further, the system may eliminate and/or reduce unnecessary hardware and/or software components and/or provide greater flexibility, accuracy, and/or functionality over previous techniques.

Each of the verification system 210, the requester device 201, the insured device 202, insurance agent device 203, and/or the insurer device 204 may be one or more of any kind of electronic device and/or devices (such as one or more devices configured in a networked configuration, cloud computing configuration, and so on). Examples of such devices include, but are not limited to, one or more desktop computing devices, laptop computing devices, server computing devices, mobile computing devices, tablet computing devices, set top boxes, digital video recorders, televisions, displays, wearable devices, smart phones, set top boxes, digital media players, and so on. The devices may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units, and/or other components. The processor may execute instructions stored in the non-transitory storage medium to perform various functions.

In various embodiments, the verification system 210 may include and/or otherwise be configured to access one or more blockchains and/or blockchain networks (which may utilize hyperledger blockchains) that may be used to stored insurance policy information and/or other information. In some embodiments, the verification system 210 may also include and/or otherwise be configured to access one or more databases and/or other data stores that may be used to store information used to interact with the one or more blockchains and/or blockchain networks. In this way, access may be provided to the one or more blockchains and/or blockchain networks while access may be prevented to the database, separating the accessibility of the information that may be used by the verification system 210. Such verification system 210 embodiments that use both the blockchains and/or blockchain networks and the database may be “hybrid systems” due to use of both the blockchains and/or blockchain networks and the database to perform one or more verification system 210 functions. In a number of embodiments, the verification system 210 may include one or more other devices that perform various verification system 210 functions, such as receiving and/or responding to verification system 210 requests, controlling access to the one or more blockchains and/or blockchain networks and/or the database, interacting with the one or more blockchains and/or blockchain networks and/or the database, performing insurance verification, and/or performing various other functions.

The verification system 210 may store the information in one or more blocks of the blockchain and/or the database in a variety of different ways. For example, the information may be stored as text data in one or blocks, which may be encrypted and referenced by a hash and/or other key. The block including the information may also specify details related to creation of the block, such as who submitted the information, a time and/or date the information was obtained and/or the block was created, data identifying the device and/or devices used to submit the information, and so on. The information may be an initial block related to an insurance policy, insured, insurer, requester, and so on and/or may be one or more updates. One or more updates may be linked to the initial block and the verification system 210 may be configured to look at the most recent block related to an insurance policy in order to access the most up to date information. In this way, any updates and/or previous data may be accessible from any block.

The verification system 210 may also store the indication of the authentication strength level in one or more blocks of the blockchain and/or the database in a variety of different ways. For example, indication of the authentication strength level may be stored as text data in one or more blocks. Such text data may specify the entity (such as the insured, the requester, an insurance agent, the insurer, and so on) who provided the information and/or verified the accuracy of the information. Such text data may also include and/or link to data used to verify the identity of the entity who provided the information and/or verified the accuracy of the information.

For example, an insured may provide information regarding one or more insurance policies to the verification system 210 via the insured device 202. The verification system 210 may assign this information a low authentication strength level because there is no additional verification beyond the assertion of the insured that the information is correct. In some implementations, the verification system 210 may verify the identity of the insured (such as by obtaining credit bureau and/or other data regarding the asserted identity of the insured and then asking the insured questions relating to such data to confirm that the insured is who the insured asserts, such as a street the person lived on during a particular time, an automobile registered to an address associated with the person at a particular time, and so on) and may assign the information a higher authentication strength level because at least the identity of the insured has been verified. In a number of examples, the data related to identity verification may be stored in the database as opposed to the blockchain.

By way of another example, a requester may provide information regarding one or more insurance policies to the verification system 210 via the requester device 201. By way of illustration, the insured may provide the information to the requester and the requester may then provide the information to the verification system 210. The verification system 210 may assign this information a low authentication strength level because there is no additional verification beyond the assertion of the requester that the information is correct. In some implementations, the verification system 210 may verify the identity of the requester (such as by obtaining credit bureau and/or other data regarding the asserted identity of the requester and then asking the requester questions relating to such data to confirm that the requester is who the requester asserts) and may assign the information a higher authentication strength level because at least the identity of the requester has been verified. In a number of examples, the data related to identity verification may be stored in the database as opposed to the blockchain.

In still another example, an insurance agent may provide information regarding one or more insurance policies to the verification system 210 via the insurance agent device 203. By way of illustration, the insurance agent may provide the information to the verification system 210 upon request of the insured, the requester, the insurer, and so on. The verification system 210 may assign this information a higher authentication strength level than information provided by the insured and/or requester because the insurance agent is licensed and/or registered as an insurance agent (which may provide a higher level of credibility due to the vetting involved in licensing and/or registering) and/or may be legally liable for providing inaccurate information. In some implementations, the verification system 210 may verify the identity of the insurance agent (such as by obtaining credit bureau and/or other data regarding the asserted identity of the insurance agent and then asking the insurance agent questions relating to such data to confirm that the insurance agent is who the insurance agent asserts, verifying that the insurance agent is licensed in a state, national, and/or other insurance agent licensing database, verifying that the insurance agent is registered in a state, national, and/or other insurance agent registration database, and so on) and may assign the information a still higher authentication strength level because the identity of the insurance agent has been verified. In a number of examples, the data related to identity verification may be stored in the database as opposed to the blockchain.

In yet another example, an insurer may provide information regarding one or more insurance policies to the verification system 210 via the insurer device 204. By way of illustration, the insurer may configure the insurer device 204 to provide data regarding one or more insurance policies to the verification system 210. The verification system 210 may assign this information a higher authentication strength level than information provided by the insured, requester, and/or the insurance agent because the insurer is the issuer of the policy and/or policies associated with the information and ultimately responsible for any asserted coverage whether accurate or not. In some implementations, the verification system 210 may verify the identity of the insurer (such as by confirming a security certificate associated with the insurer, confirming that the insurer device 204 is associated with the insurer, configuring a secure communication with the insurer device 204 over which the information is received, providing the insurer security credentials that are used to submit the information, and so on) and may assign the information a still higher authentication strength level because the identity of the insurer has been verified. In a number of examples, the data related to identity verification may be stored in the database as opposed to the blockchain.

Although the above describes assigning an authentication strength level according to the entity that provided the information, it is understood that this is an example. In some examples, one or more entities may endorse the information after information is added to the blockchain. Such endorsements may be stored as subsequent blocks in the blockchain and/or otherwise used to modify the existing block. The authentication strength level of the information may be determined to be the highest authentication strength level associated with the information in the blockchain. By way of illustration, the information may be determined to be the highest strength level when initially submitted by the insured and/or requester, subsequently endorsed as accurate by the insured's and/or the requester's insurance agent, and then subsequently endorsed by the insurer associated with the information. Various configurations are possible and contemplated without departing from the scope of the present disclosure.

In various implementations, the verification system 210 may be operable to determine one or more sets of requirements for the requester. For example, the insured may be a contractor or vendor with whom the requester has formed one or more contracts that require one or more insurance coverages. The verification system 210 may obtain and/or determine one or more sets of requirements related to the coverage required by the one or more contracts (which may be specified by the contract, required by a legal and/or other authority, and so on), connect one or more profiles associated with the requester and/or the insured, compare the one or more sets of requirements to the information regarding the coverage (or generate such a comparison), and/or perform other actions. For example, the verification system 210 may track coverage in force, coverage that needs to be obtained, provide one or more attestations regarding coverage in force to be obtained, demonstrate compliance with the one or more sets of requirements, determine that coverage has changed, re-compare coverage to the one or more sets of requirements upon determining that the coverage and/or the one or more sets of requirements has changed, provide notifications to the requester and/or the insured and/or one or more other entities regarding one or more of the preceding (such as prompts to review and/or provide information and so on), and so on.

By way of example, a requester may provide the verification system 210 data regarding a contract that the requester has entered into to have a contractor or vendor construct a new factory. A contract for constructing a new factory may require the contractor or vendor have general liability coverage in place for the construction as well as worker's compensation coverage, but also automobile liability coverage for automobiles used during construction. The verification system 210 may determine the set of requirements as the coverages required for the contract. The verification system 210 may also look up a profile associated with the contractor or vendor using a name of the contractor or vendor specified by the requester, obtain consent from the contractor or vendor to link the profile to the requester so that information for the contractor or vendor may be used, link the profile accordingly, analyze information for one or more insurance policies stored for the contractor or vendor, compare the set of requirements to the information (or generate such a comparison), and take one or more actions according to the comparison. For example, the verification system 210 may determine that the required general liability coverage and workers' compensation coverage is in place, but that the automobile liability coverage is missing. The verification system 210 may then notify the requester and/or the insured of the missing coverage in order to prompt for that coverage to be obtained and/or for the contract to be voided for lack of required coverage.

The above is described as the verification system 210 determining the set of requirements as the coverages required for the contract. However, it is understood that this is an example. In other examples, the requester may determine the set of requirements. For example, the requester may set custom requirements he deems fit for the work being conducted via the requester device 201.

In implementations where the verification system 210 determines the set of requirements, the verification system 210 may perform a series of operations that evaluates the type of work being conducted and various other factors to determine set of requirements appropriate for the work being conducted. Such operations may consider: the type of work and/or trade involved (for example, a tree cutter may involve more risk than a landscaper), the contract value and/or contract price, geographic location hazards and/or CAT zones (areas prone to catastrophic natural disasters) (such as location near coastal waters, terrorism risks, earthquakes, fire, flood, windstorms, and so on), where the work is being conducted (for example, electrical work conducted in a nuclear power plant may involve more risk than electrical work in a home), and so on.

By way of another example, the verification system 210 may determine that the set of requirements requires a particular authentication strength level and may evaluate the information and/or the set of requirements to determine if that particular authentication strength level is met. Various configurations are possible and contemplated without departing from the scope of the present disclosure.

In various embodiments, an insured may use the verification system 210 to provide one or more attestations regarding the insured's coverage. For example, an insured may log into an account the insured has configured in the verification system 210 and provide contact information for a requester, which the verification system 210 may then use to contact the requester in order to enable the requester to access blocks in the blockchain with hashes or other keys associated with the insured and/or ones of such blocks to which the insured has authorized the requester to access. In other examples, the requester may also have an account in the verification system 210 and the insured may search for the requester's account and indicate such in order to have the verification system 210 contact the requester. In still other examples, the insured may directly provide the requester with one or more hashes or keys for blocks to which the insured wishes the requester to be able to access, and/or provide another kind of access mechanism to such (such as by providing one or more quick response codes and/or other mechanisms that may be scanned or otherwise used to access associated information, submit claims, and so on). Various configurations are possible and contemplated without departing from the scope of the present disclosure.

In other embodiments, the requester and the insured may not have a previous relationship. The requester may provide the verification system 210 with the set of requirements and/or data that the verification system 210 uses to determine the set of requirements and then provide a list of insureds who have insurance policy information satisfying the set of requirements. For example, the requester may use the verification system 210 to find contractors or vendors who have sufficient coverage limits to satisfy the requirements of a contract and then request to connect to one or more of the contractors or vendors in order to attempt to form the contract with a suitably insured contractor or vendor. By way of another example, the requester may not understand coverage required or suitable for an activity but may provide data regarding the activity to the verification system 210 and the verification system 210 may determine the coverage required or suitable for the activity and provide a list of contractors or vendors who have information associated with that coverage. Various configurations are possible and contemplated without departing from the scope of the present disclosure.

In various embodiments, various entities who may have endorsed insurance policy information may be liable for the accuracy of that information due to the endorsement. Thus, such entities may subsequently use the verification system 210 to review the information to ensure that it is still accurate and/or may use the verification system 210 to take actions to correct inaccurate information that they have previously endorsed. In some examples, the verification system 210 may determine one or more changes related to the information (such as coverage changes, changes to one or more sets of requirements, and so on) and notify entities who endorsed the information and/or other parties so that such entities and/or other parties may take actions to respond to such changes (such as revoking one or more endorsements, instructing a requester to cancel a contract, and so on).

In a number of embodiments, the verification system 210 may be operable to receive one or more claims related to one or more insurance policies associated with the information. The verification system 210 may be operable to store information related to such claims in association with the information on the one or more insurance policies, process such claims and/or contact another entity and/or device to do so, and so on. For example, in some implementations, the verification system 210 may use stored information to determine that a claim is covered, that the authentication strength level of stored insurance policy information is above a threshold, pay the claim to become subrogated to recovery under the insurance policy, and process the claim to collect the recovery after having paid the claim. In various embodiments, the verification system 210 may discount the claim payment in exchange for paying prior to recovery. In a number of implementations, the verification system 210 may discount the claim payment more for claims related to insurance policy information with lower authentication strength levels than for claims related to insurance policy information with higher. authentication strength levels. By way of another example, the verification system 210 may be operable to support an automobile insurance exchange and/or processing system where parties to an incident are able to use a mobile device to provide access to relevant insurance policy information (such as by presenting and/or scanning one or more quick response codes and/or other mechanisms), initiate one or more claims for processing, and so on. Various configurations are possible and contemplated without departing from the scope of the present disclosure.

Although examples above are illustrated and described in the context of contracts involving contractors or vendors, it is understood that this is an example. In various implementations, the techniques illustrated and described herein may be used in various contexts without departing from the present disclosure. Examples including money lending, banking, landlord/tenant relationships, land sales, government and/or licensed professionals, business and vendor relationships, lender and borrower relationships, contractor and homeowner relationships, buyer and seller relationships, lessor/lessee relationships, real estate, oil and gas, retail, health, construction, transportation, financial, technology, agriculture, food, medical, compliance, and so on. Various configurations are possible and contemplated without departing from the scope of the present disclosure.

Although the system 200 is illustrated and described as including particular components that perform particular functions, it is understood that this is an example. In other implementations, other arrangements may be used. For example, in some examples, the insurer device 204 may be omitted and/or may not be configured to communicate with the verification system 210 and/or the insurance agent device 203. Various configurations are possible and contemplated without departing from the present disclosure.

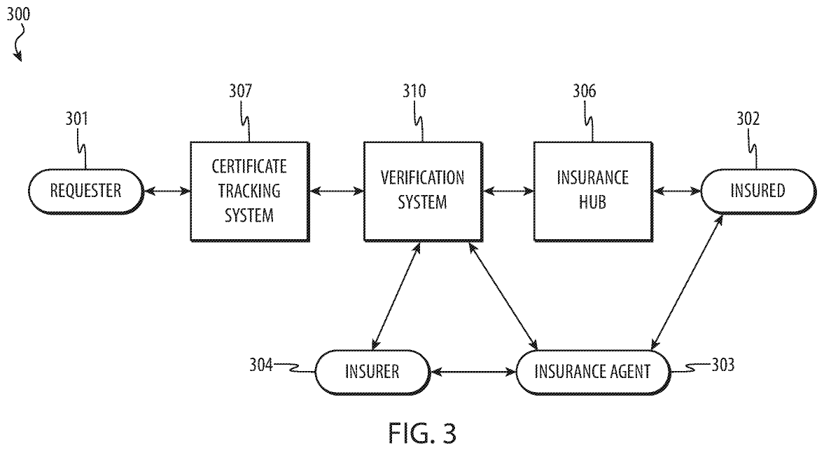

FIG. 3 depicts a third example insurance verification system 300. The system 300 may be a blockchain insurance verification system. Similar to the system 200 of FIG. 2, the system 300 may include a verification system 310 that may be operable to communicate with one or more requesters 301, one or more insureds 302, one or more insurance agents 303, and/or one or more insurers 304. The verification system 310 may be operable to perform the same and/or similar functions as discussed above with respect to the verification system 210 of FIG. 2. By way of contrast with the system 200 of FIG. 2, the requester 301 may communicate with the verification system 310 via a certificate tracking system 307 (and/or any other kind of system, such as a partner integration with a real estate software, accounting software, and so on) and/or the insured 302 may communicate with the verification system 310 via an insurance hub 306.

The certificate tracking system 307 may be configured to perform a variety of functions related to the requester 301 interacting with the verification system 310. In some examples, the certificate tracking system 307 may be implemented by the verification system 310 and/or one or more other devices that interact with the verification system 310 (such as a computing device executing an internet browser that interfaces with the verification system 310). Various configurations are possible and contemplated without departing from the scope of the present disclosure.

Similarly, the insurance hub 306 may be configured to perform a variety of functions related to the insured 302 interacting with the verification system 310. In some examples, the insurance hub 306 may be implemented by the verification system 310 and/or one or more other devices that interact with the verification system 310 (such as a computing device executing an internet browser that interfaces with the verification system 310). Various configurations are possible and contemplated without departing from the scope of the present disclosure.

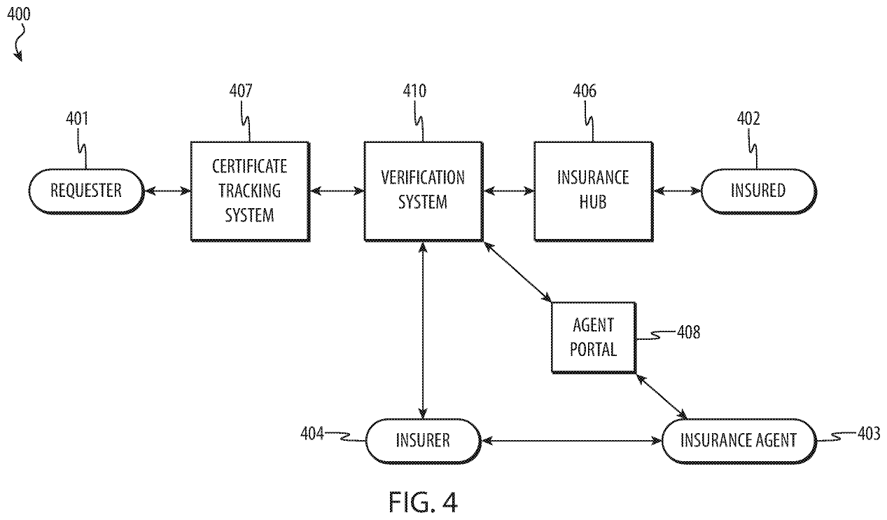

FIG. 4 depicts a fourth example insurance verification system 400. The system 400 may be a blockchain insurance verification system. Similar to the system 300 of FIG. 3, the system 400 may include a verification system 410 that may be operable to communicate with one or more requesters 401 via one or more certificate tracking systems 407, one or more insureds 402 via one or more insurance hubs 406, one or more insurance agents 403, and/or one or more insurers 404. The verification system 410 may be operable to perform the same and/or similar functions as discussed above with respect to the verification system 210 of FIG. 2. By way of contrast with the system 300 of FIG. 3, the insurance agent 403 may communicate with the verification system 410 via an agent portal 408.

The agent portal 408 may be configured to perform a variety of functions related to the insurance agent 403 interacting with the verification system 410. In some examples, the agent portal 408 may be implemented by the verification system 410 and/or one or more other devices that interact with the verification system 410 (such as a computing device executing an internet browser that interfaces with the verification system 410). Various configurations are possible and contemplated without departing from the scope of the present disclosure.

Additionally, in various examples, the system 400 may further include an insurer portal. Such an insurer portal may facilitate communication between the insurer 404 and the verification system 410. In some examples, the insurer portal may be implemented by the verification system 410 and/or one or more other devices that interact with the verification system 410 (such as a computing device executing an internet browser that interfaces with the verification system 410). Various configurations are possible and contemplated without departing from the scope of the present disclosure.

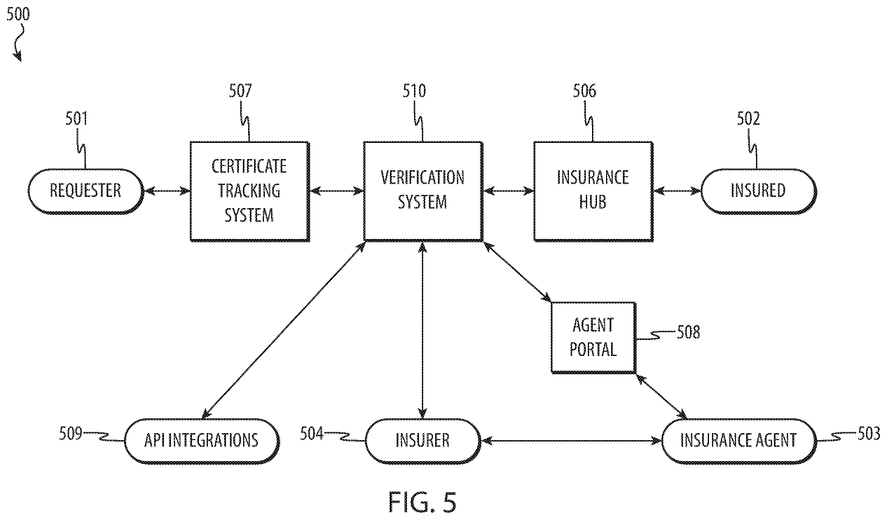

FIG. 5 depicts a fifth example insurance verification system 500. The system 500 may be a blockchain insurance verification system. Similar to the system 400 of FIG. 4, the system 500 may include a verification system 510 that may be operable to communicate with one or more requesters 501 via one or more certificate tracking systems 507, one or more insureds 502 via one or more insurance hubs 506, one or more insurance agents 503 via one or more agent portals 508, and/or one or more insurers 504. The verification system 510 may be operable to perform the same and/or similar functions as discussed above with respect to the verification system 210 of FIG. 2. By way of contrast with the system 400 of FIG. 4, the system 500 may also include one or more application programming interface or “API” integrations 509.

The API integrations 509 may be one or more application programming interfaces that various programs and/or devices may utilize in order to interact with the verification system 510. Such API integrations 509 may be used by the various programs and/or devices to perform similar functions to those discussed with respect to FIGS. 2-4 above, additional functions, and so on. Various configurations are possible and contemplated without departing from the scope of the present disclosure.

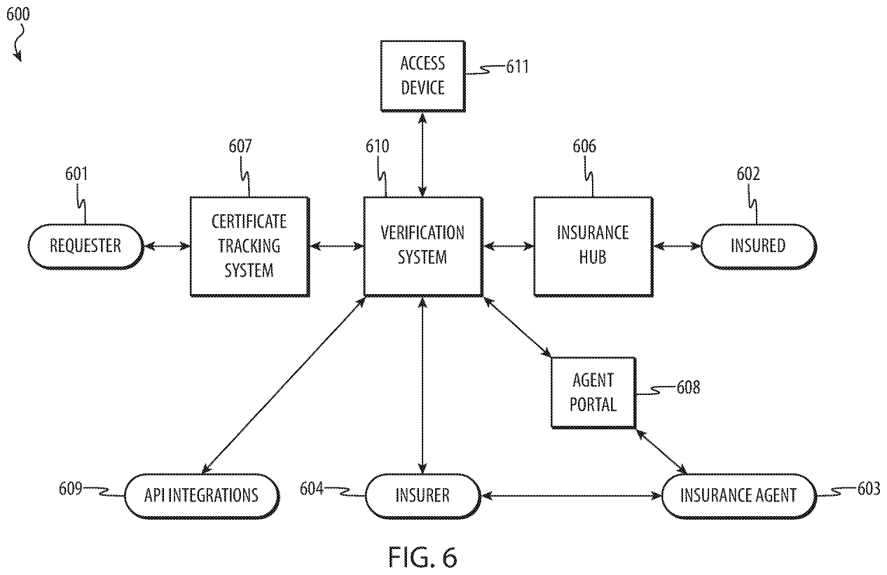

FIG. 6 depicts a sixth example insurance verification system 600. The system 600 may be a blockchain insurance verification system. Similar to the system 500 of FIG. 5, the system 600 may include a verification system 610 that may be operable to communicate with one or more requesters 601 via one or more certificate tracking systems 607, one or more insureds 602 via one or more insurance hubs 606, one or more insurance agents 603 via one or more agent portals 608, one or more insurers 604, and/or one or more API integrations 609. The verification system 610 may be operable to perform the same and/or similar functions as discussed above with respect to the verification system 210 of FIG. 2. By way of contrast with the system 500 of FIG. 5, the verification system 610 may also be operable to communicate with one or more other access devices 611.

The access devices 611 may be any kind of device operable to communicate with the verification system 610. Examples of such devices include, but are not limited to, one or more desktop computing devices, laptop computing devices, server computing devices, mobile computing devices, tablet computing devices, set top boxes, digital video recorders, televisions, displays, wearable devices, smart phones, set top boxes, digital media players, and so on. The access devices 611 may communicate with the verification system 610 to perform similar functions to those discussed with respect to FIGS. 2-5 above, additional functions, and so on. Various configurations are possible and contemplated without departing from the scope of the present disclosure.

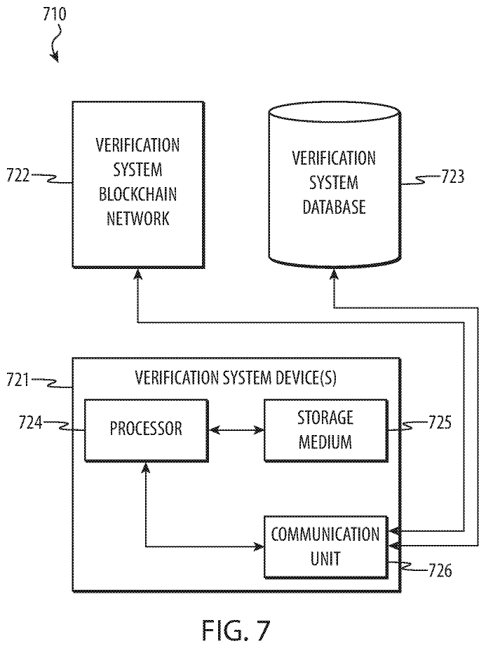

FIG. 7 depicts an example implementation of a verification system 710 that may be used in one or more of the systems 200-600 of FIGS. 2-6. The verification system 710 may include one or more verification system blockchain networks 722 (which may utilize hyperledger fabric blockchains), one or more verification system databases 723, and/or one or more verification system devices 721. The verification system 710 embodiments may be a hybrid system due to the verification system 710 using both the verification system blockchain network 722 and the verification system database 723 to perform various verification system 710 functions.

The verification system device 721 may interact with the verification system blockchain network 722 and/or the verification system database 723 and/or control interaction of other devices with the verification system blockchain network 722 and/or the verification system database 723. In some embodiments, the verification system blockchain network 722 may be used to store insurance policy information, information regarding one or more sets of requirements, and/or other information that the verification system device 721 may make accessible to one or more other devices in one or more ways under one or more conditions. In various embodiments, the verification system database 723 may be used to store data that the verification system device 721 may use to interact with other devices and/or the verification system blockchain network 722 but that the verification system device 721 does not make accessible to the other devices and/or otherwise isolates from the other devices. For example, data related to verification of identities of insureds, requesters, insurance agents, insurers, and so on (which may include information that is kept confidential, such as social security numbers, dates of birth, and/or other sensitive information) may be stored in the verification system database 723. Various configurations are possible and contemplated without departing from the scope of the present disclosure.

The verification system device 721 may perform various verification system 710 functions, such as receiving and/or responding to verification system 710 requests, controlling access to the one or more blockchains and/or blockchain networks and/or the database, interacting with the one or more blockchains and/or blockchain networks and/or the database, performing insurance verification, and/or performing various other functions. The verification system device 721 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, set top boxes, digital media players, and so on. The verification system device 721 may include one or more processors 724 and/or other processing units and/or controllers, one or more non-transitory storage media 725 (which may take the form of, but is not limited to, a magnetic storage medium; optical storage medium; magneto-optical storage medium; read only memory; random access memory; erasable programmable memory; flash memory; and so on), one or more communication units 726, and/or other components. The processor may execute instructions stored in the non-transitory storage medium to perform various functions. Such functions may include any of the verification system functions discussed above, additional functions, and so on.

Although the verification system 710 is illustrated and described as including particular components arranged in a particular configuration, it is understood that this is an example. In a number of implementations, various configurations of various components may be used without departing from the scope of the present disclosure.

For example, the verification system 710 is illustrated and described as including the verification system blockchain network 722 and the verification system database 723. However, it is understood that this is an example. In various implementations, one or more of the verification system blockchain network 722 and the verification system database 723 may be external to the verification system 710 and the verification system 710 may be configured to access and/or control access to one or more of the verification system blockchain network 722 and the verification system database 723. Various configurations are possible and contemplated without departing from the scope of the present disclosure.

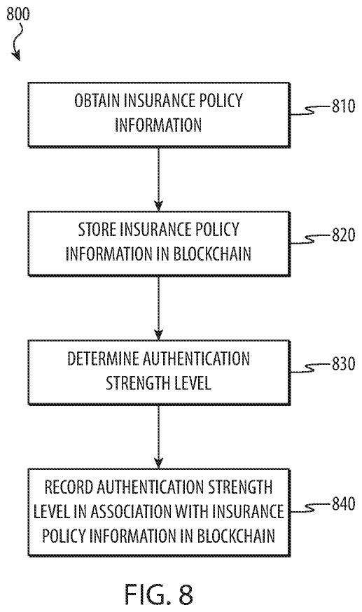

FIG. 8 depicts a flow chart illustrating a first example method 800 for operating an insurance verification system. This method 800 may be performed by one or more of the systems 200-600 and 710 of FIGS. 2-7.

At operation 810, an electronic device (such as the verification system device 721 of FIG. 7) may obtain insurance policy information. The electronic device may obtain the insurance policy information from one or more insureds, requesters, insurance agents, insurers, and so on. Additionally, the electronic device may obtain one or more endorsements of such insurance policy information from one or more insureds, requesters, insurance agents, insurers, and so on.

At operation 820, the electronic device may store the insurance policy information in one or more blockchains. In examples where one or more endorsements of such insurance policy information are received, the electronic device may also store the one or more endorsements of such insurance policy information.

At operation 830, the electronic device may determine an authentication strength level of the insurance policy information. In examples where one or more endorsements of such insurance policy information are received, the electronic device may determine an authentication strength level of the endorsements of such insurance policy information.

At operation 840, the electronic device may record the authentication strength level in association with the insurance policy information in the blockchain. In some implementations, the electronic device may record the authentication strength level in one or more new blocks connected to one or more existing blocks that store the insurance policy information. In other implementations, the electronic device may record the authentication strength level in one or more existing blocks that store the insurance policy information. Various configurations are possible and contemplated without departing from the scope of the present disclosure.

For example, the insurance policy information may correspond to one or more insurance policies covering a contractor or vendor who has formed a contract to provide goods and/or services to another party. The electronic device may determine the authentication strength level according to whether the insurance policy information is provided by (and/or endorsed by) the contractor or vendor, the other party, one or more insurance agents, the insurer who issued the insurance policies, an entity whose identity has been verified, and so on. In some examples, insurance agents who underwrote an insurance policy may be associated with higher authentication strength levels than insurance agents who were involved with an insurance policy, though uninvolved insurance agents may still be associated with higher authentication strength levels than people who are not insurance agents, licensed, and so on. Various configurations are possible and contemplated without departing from the scope of the present disclosure.

In various examples, this example method 800 may be implemented as a group of interrelated software modules or components that perform various functions discussed herein. These software modules or components may be executed within a cloud network and/or by one or more computing devices, such as one or more components of one or more of the systems 200-600 of FIGS. 2-6 and/or the verification system device 721 of FIG. 7.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as storing the insurance policy information and determining and recording the authentication strength level as separate, sequentially performed operations. However, it is understood that this is an example. In various implementations, the electronic device may determine and record the authentication strength level as part of storing the insurance policy information. Various configurations are possible and contemplated without departing from the scope of the present disclosure.

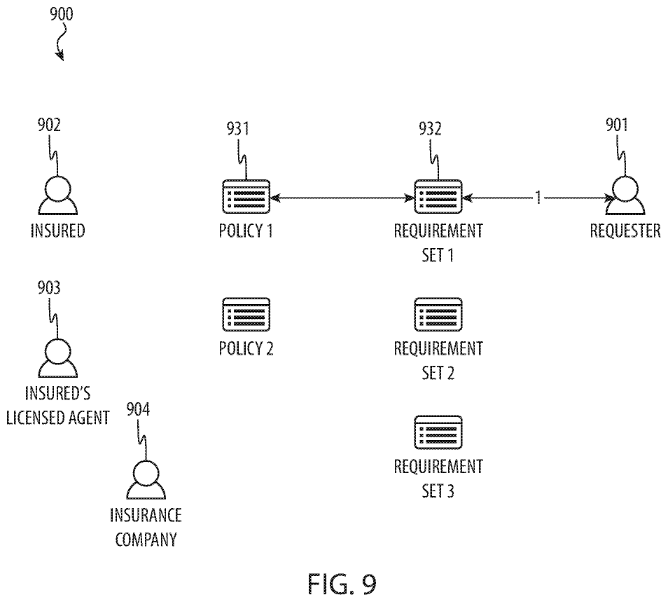

FIG. 9 depicts a first example process 900 for determining an authentication strength level. This process 900 may be used in one or more of the systems 200-600, 710 of FIGS. 2-6 and 7 and/or the method 800 of FIG. 8.

The process 900 may involve a requester 901, an insured 902, a licensed agent 903 (such as a licensed insurance agent), and an insurance company 904 or insurer. The requester 901 may provide information on a number of requirement sets 932 (such as for a number of contracts formed with the insured 902) to a verification system, as well as information on a number of insurance policies 931 that are associated with the insured 902. The verification system may assign the insurance policies 931 a first authentication strength level because the information on the insurance policies 931 is obtained from the requester 901 as opposed to the licensed agent 903 and/or the insurance company 904.

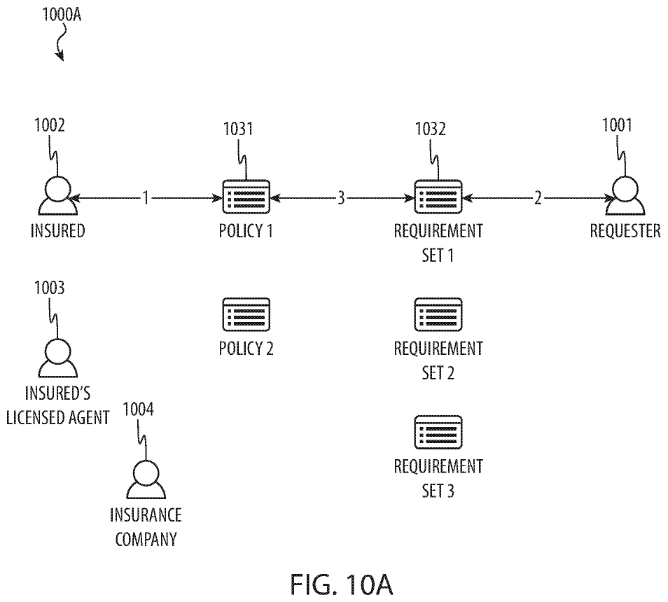

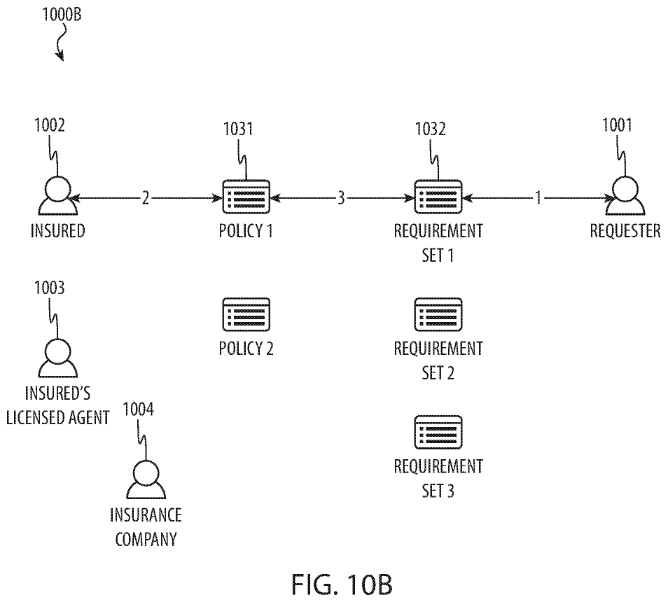

FIG. 10A depicts a second example process 1000A for determining an authentication strength level. This process 1000A may be used in one or more of the systems 200-600, 710 of FIGS. 2-6 and 7 and/or the method 800 of FIG. 8.

The process 1000A may involve a requester 1001, an insured 1002, the insured's licensed agent 1003, and an insurance company 1004 or insurer. The insured 1002 may provide a verification system information on a number of insurance policies 1031 that are associated with the insured 1002. The requester 1001 may then provide information on a number of requirement sets 1032 (such as for a number of contracts formed with the insured 1002) to the verification system and link the requirement sets 1032 to the insurance policies 1031. For example, the requester 1001 may use the verification system to look up the insured 1002 and request connection to the insured 1002 (which may involve endorsement of the information in the insurance policies 1031), whereupon the requirement sets 1032 may be linked to the insurance policies 1031 upon acceptance of the connection by the insured 1002. Such connections may operate as a digital handshake similar to how connections are formed in social media networks. The verification system may assign the insurance policies 1031 a second authentication strength level that is higher than the first authentication strength level of the process 900 of FIG. 9 because the information on the insurance policies 1031 and the information on the requirement sets 1032 is obtained from (and/or endorsed by) both the requester 1001 and the insured 1002 as opposed to just one of the requester 1001 and the insured 1002 and/or from the insured's licensed agent 1003 and/or the insurance company 1004.

FIG. 10B depicts a third example process 1000B for determining an authentication strength level. This process 1000B may be used in one or more of the systems 200-600, 710 of FIGS. 2-6 and 7 and/or the method 800 of FIG. 8.

The process 1000B may involve a requester 1001, an insured 1002, the insured's licensed agent 1003, and an insurance company 1004 or insurer. The requester 1001 may provide information on a number of requirement sets 1032 (such as for a number of contracts formed with the insured 1002) to a verification system. The insured 1002 may then provide the verification system information on a number of insurance policies 1031 that are associated with the insured 1002. The insured 1002 and/or the requester 1001 may then link the requirement sets 1032 to the insurance policies 1031. The verification system may assign the insurance policies 1031 a second authentication strength level that is higher than the first authentication strength level of the process 900 of FIG. 9 because the information on the insurance policies 1031 and the information on the requirement sets 1032 is obtained from (and/or endorsed by) both the requester 1001 and the insured 1002 as opposed to just one of the requester 1001 and the insured 1002 and/or from the insured's licensed agent 1003 and/or the insurance company 1004.

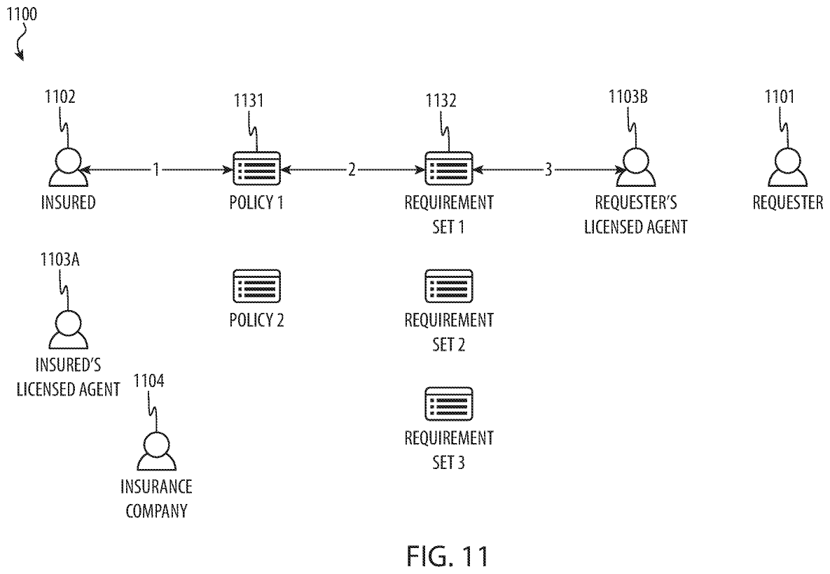

FIG. 11 depicts a fourth example process 1100 for determining an authentication strength level. This process 1100 may be used in one or more of the systems 200-600, 710 of FIGS. 2-6 and 7 and/or the method 800 of FIG. 8.

The process 1100 may involve a requester 1101, an insured 1102, the insured's licensed agent 1103A, the requester's licensed agent 1103B, and an insurance company 1104 or insurer. The insured 1102 may provide information to a verification system on a number of insurance policies 1131 associated with the insured and link the insurance policies to a number of requirement sets 1132 (such as for a number of contracts formed between the insured 1102 and the requester 1101). The requester's licensed agent 1103B may endorse that the information for the insurance policies 1131 is accurate. The verification system may assign the insurance policies 1131 a third authentication strength level that is higher than the second authentication strength level of the processes 1000A, 1000B of FIGS. 10A and 10B because the information on the insurance policies 1131 is endorsed by a licensed agent (though not one associated with the insurance policies 1131) as opposed to being provided and/or endorsed by the requester 1101, the insured 1102, and/or the insurance company 1104.

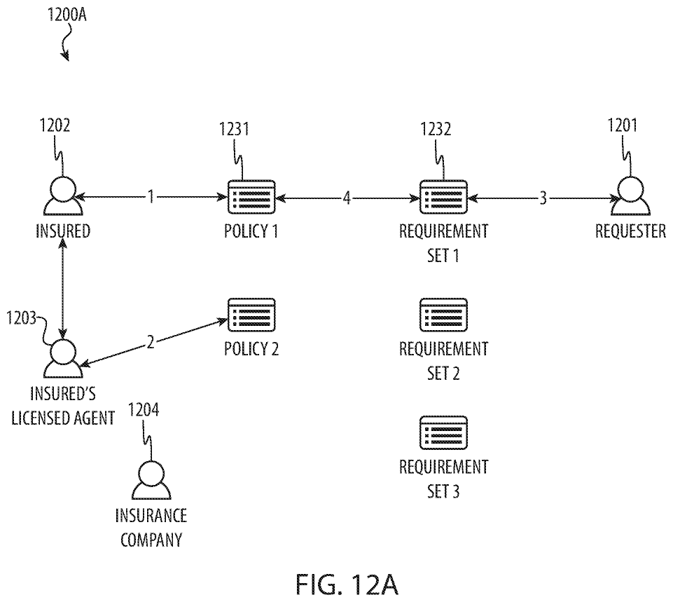

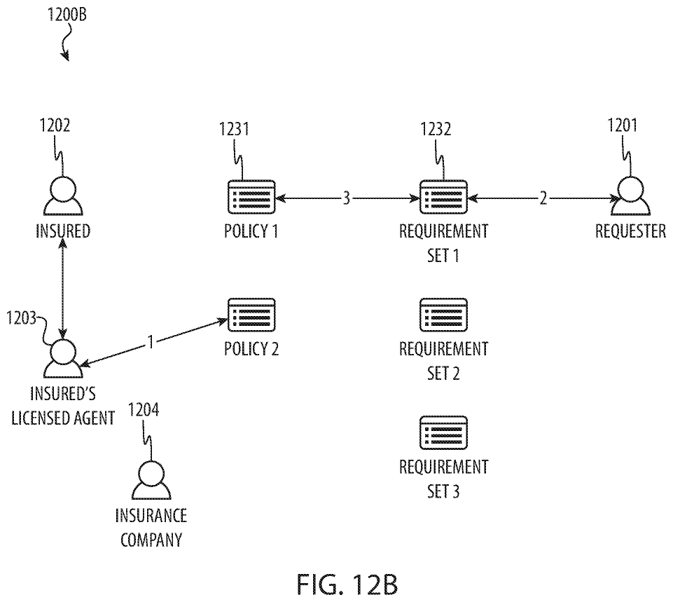

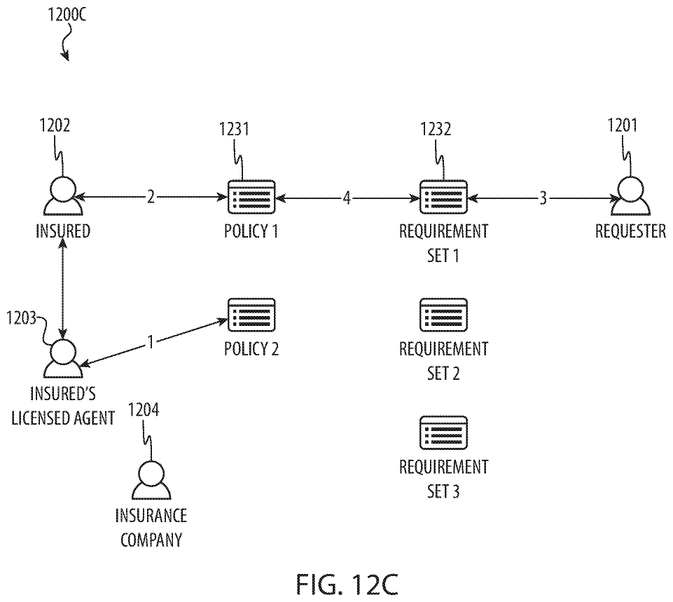

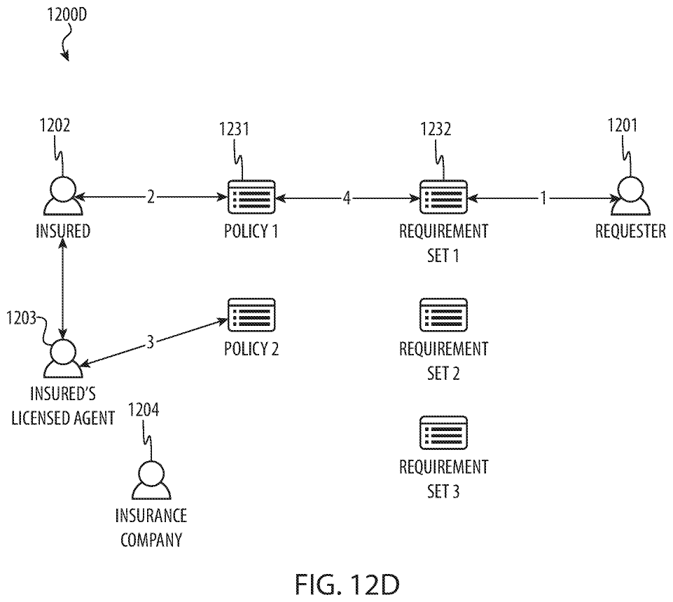

FIG. 12A depicts a fifth example process 1200A for determining an authentication strength level. This process 1200A may be used in one or more of the systems 200-600, 710 of FIGS. 2-6 and 7 and/or the method 800 of FIG. 8.

The process 1200A may involve a requester 1201, an insured 1202, the insured's licensed agent 1203, and an insurance company 1204 or insurer. The insured 1202 may provide information to a verification system on a number of insurance policies 1231 associated with the insured 1202. The insured's licensed agent 1203 may then endorse that the information for the insurance policies 1231 is accurate. The requester 1201 may then provide information on a number of requirement sets 1232 (such as for a number of contracts formed with the insured 1202) and link the requirement sets 1232 to the insurance policies 1231. The verification system may assign the insurance policies 1231 a fourth authentication strength level that is higher than the third authentication strength level of the process 1100 of FIG. 11 because the information on the insurance policies 1231 is endorsed by a licensed agent associated with the insurance policies 1231 as opposed to being provided and/or endorsed by an unassociated licensed agent, the requester 1201, the insured 1202, and/or the insurance company 1204.

FIG. 12B depicts a sixth example process 1200B for determining an authentication strength level. This process 1200B may be used in one or more of the systems 200-600, 710 of FIGS. 2-6 and 7 and/or the method 800 of FIG. 8.

The process 1200B may involve a requester 1201, an insured 1202, the insured's licensed agent 1203, and an insurance company 1204 or insurer. The insured's licensed agent 1203 may provide information to a verification system on a number of insurance policies 1231 associated with the insured 1202. The requester 1201 may then provide information on a number of requirement sets 1232 (such as for a number of contracts formed with the insured 1202) and link the requirement sets 1232 to the insurance policies 1231. The verification system may assign the insurance policies 1231 a fourth authentication strength level that is higher than the third authentication strength level of the process 1100 of FIG. 11 because the information on the insurance policies 1231 is provided by a licensed agent associated with the insurance policies 1231 as opposed to being provided and/or endorsed by an unassociated licensed agent, the requester 1201, the insured 1202, and/or the insurance company 1204.

FIG. 12C depicts a seventh example process 1200C for determining an authentication strength level. This process 1200C may be used in one or more of the systems 200-600, 710 of FIGS. 2-6 and 7 and/or the method 800 of FIG. 8.

The process 1200C may involve a requester 1201, an insured 1202, the insured's licensed agent 1203, and an insurance company 1204 or insurer. The insured's licensed agent 1203 may provide information to a verification system on a number of insurance policies 1231 associated with the insured 1202. The insured 1202 may then endorse that the information for the insurance policies 1231 is accurate. The requester 1201 may then provide information on a number of requirement sets 1232 (such as for a number of contracts formed with the insured 1202) and link the requirement sets 1232 to the insurance policies 1231. The verification system may assign the insurance policies 1231 a fourth authentication strength level that is higher than the third authentication strength level of the process 1100 of FIG. 11 because the information on the insurance policies 1231 is provided by a licensed agent associated with the insurance policies 1231 and endorsed by the insured 1202 as opposed to being provided and/or endorsed by an unassociated licensed agent, the requester 1201, and/or the insurance company 1204.

FIG. 12D depicts an eighth example process 1200D for determining an authentication strength level. This process 1200D may be used in one or more of the systems 200-600, 710 of FIGS. 2-6 and 7 and/or the method 800 of FIG. 8.

The process 1200D may involve a requester 1201, an insured 1202, the insured's licensed agent 1203, and an insurance company 1204 or insurer. The requester 1201 may provide information to a verification system on a number of requirement sets 1232 (such as for a number of contracts formed with the insured 1202). The insured 1202 may then provide information to the verification system on a number of insurance policies 1231 associated with the insured 1202. The insured's licensed agent 1203 may then endorse that the information for the insurance policies 1231 is accurate. The insured 1202 and/or the requester 1201 may then link the requirement sets 1232 to the insurance policies 1231. The verification system may assign the insurance policies 1231 a fourth authentication strength level that is higher than the third authentication strength level of the process 1100 of FIG. 11 because the information on the insurance policies 1231 is endorsed by a licensed agent associated with the insurance policies 1231 as opposed to being provided and/or endorsed by an unassociated licensed agent, the requester 1201, and/or the insurance company 1204.

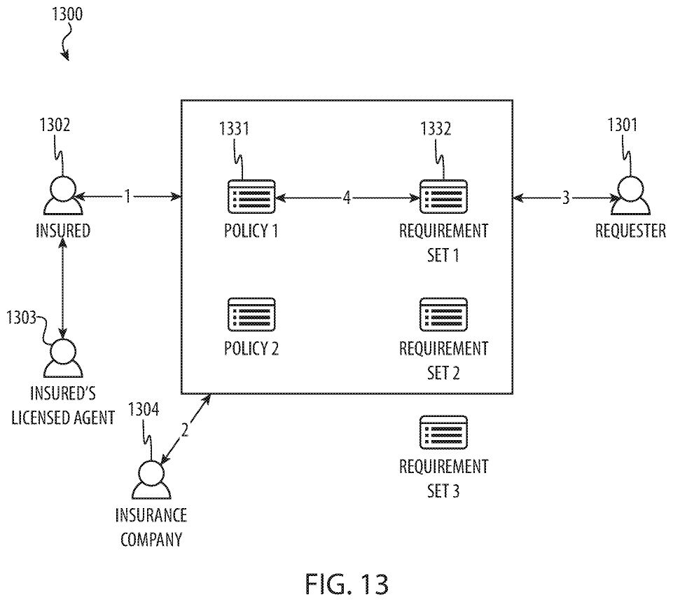

FIG. 13 depicts a ninth example process 1300 for determining an authentication strength level. This process 1300 may be used in one or more of the systems 200-600, 710 of FIGS. 2-6 and 7 and/or the method 800 of FIG. 8.

The process 1300 may involve a requester 1301, an insured 1302, the insured's licensed agent 1303, and an insurance company 1304 or insurer. The insured 1302 may provide information to a verification system on a number of insurance policies 1331 associated with the insured 1302. The insurance company 1304 may then endorse that the information for the insurance policies 1331 is accurate. The requester 1301 may provide information to a verification system on a number of requirement sets 1332 (such as for a number of contracts, some of which may be formed with the insured 1302 and some of which may be unrelated to the insured 1302 and/or the insurance policies 1331). The insured 1302 and/or the requester 1301 may then link a number of the requirement sets 1332 to the insurance policies 1331. The verification system may assign the insurance policies 1331 a fifth authentication strength level that is higher than the fourth authentication strength level of the processes 1200A-1200D of FIGS. 12A-12D because the information on the insurance policies 1331 is endorsed by the insurance company 1304 as opposed to being provided and/or endorsed by the requester 1301 and/or a licensed agent.

Although a number of different authentication strength levels and/or parameters for determining such are discussed herein, it is understood that these are for the purposes of example. In various implementations, any system of authentication strength levels and/or parameters for determining such may be used without departing from the scope of the present disclosure.

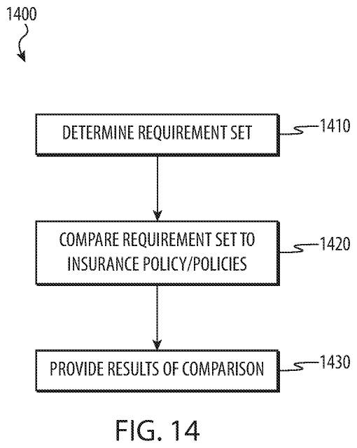

FIG. 14 depicts a flow chart illustrating a second example 1400 for operating an insurance verification system. This method 1400 may be performed by one or more of the systems 200-600 and 710 of FIGS. 2-7.

At operation 1410, an electronic device (such as the verification system device 721 of FIG. 7) may determine one or more requirement sets. The requirement set may correspond to insurance coverage requirements, such as insurance requirements for one or more contracts. The electronic device may determine the requirement set using input from one or more requesters. Alternatively, the electronic device may receive the requirement set from the requester instead of determining the requirement set. Various configurations are possible and contemplated without departing from the scope of the present disclosure.

At operation 1420, the electronic device may compare the requirement set to one or more insurance policies (or generate such a comparison). For example, the electronic device may determine that the insurance policy or policies meet the requirements of the requirement set, are missing coverage relating to such requirements, have an authentication strength level specified by such requirements, do not have such a sufficient authentication strength level, and so on.

At operation 1430, the electronic device may provide the results of the comparison. Such results may be used to demonstrate compliance with the requirements, provide evidence to cancel a contract due to failure to meet the requirements, indicate additional coverage that is to be obtained, and so on.

In various examples, this example method 1400 may be implemented as a group of interrelated software modules or components that perform various functions discussed herein. These software modules or components may be executed within a cloud network and/or by one or more computing devices, such as one or more components of one or more of the systems 200-600 of FIGS. 2-6 and/or the verification system device 721 of FIG. 7.

Although the example method 1400 is illustrated and described as including particular operations performed in a particular order, it is understood that this is an example. In various implementations, various orders of the same, similar, and/or different operations may be performed without departing from the scope of the present disclosure.

For example, the method 1400 may include additional operations. Such additional operations may include receiving information regarding the insurance policy or policies, determining an authentication strength level of the insurance policy or policies, taking one or more actions using and/or based on the comparison, and so on. Various configurations are possible and contemplated without departing from the scope of the present disclosure.

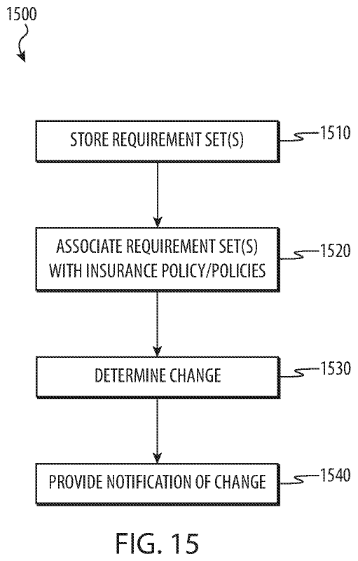

FIG. 15 depicts a flow chart illustrating a third example 1500 for operating an insurance verification system. This method 1500 may be performed by one or more of the systems 200-600 and 710 of FIGS. 2-7.

At operation 1510, an electronic device (such as the verification system device 721 of FIG. 7) may store one or more requirement sets. The requirement set may correspond to insurance coverage requirements, such as insurance requirements for one or more contracts. The electronic device may receive the requirement set from one or more requesters.

At operation 1520, the electronic device may associate the requirement set with one or more insurance policies. The insurance policies may be associated with one or more authentication strength levels.

At operation 1530, the electronic device may determine one or more changes. The one or more changes may be a change to one or more requirements of the requirement set, coverage relating to one or more of the insurance policies, and so on.

At operation 1540, the electronic device may provide a notification of the change. The electronic device may provide the notification to a requester associated with the requirement set, an insured associated with one or more of the insurance policies, an entity who has provided and/or endorsed the requirement set or one or more of the insurance policies, and insurer and/or insurance agent associated with one or more of the insurance policies, and so on.

In various examples, this example method 1500 may be implemented as a group of interrelated software modules or components that perform various functions discussed herein. These software modules or components may be executed within a cloud network and/or by one or more computing devices, such as one or more components of one or more of the systems 200-600 of FIGS. 2-6 and/or the verification system device 721 of FIG. 7.

Although the example method 1500 is illustrated and described as including particular operations performed in a particular order, it is understood that this is an example. In various implementations, various orders of the same, similar, and/or different operations may be performed without departing from the scope of the present disclosure.

For example, the method 1500 is illustrated and described as determining a change and providing a notification of the change. However, it is understood that this is an example. In some implementations, the method 1500 may determine that a change has not occurred. In such a situation, the method 1500 may continue to monitor for changes as opposed to providing one or more notifications. Various configurations are possible and contemplated without departing from the scope of the present disclosure.

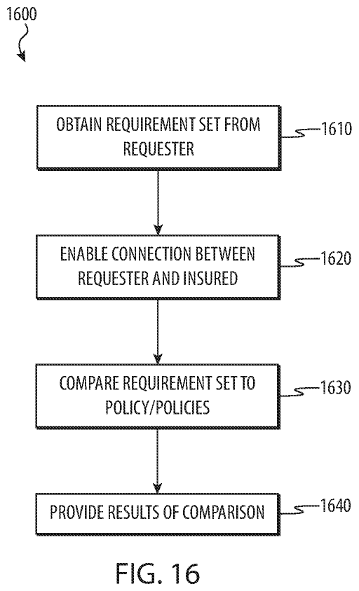

FIG. 16 depicts a flow chart illustrating a fourth example 1600 for operating an insurance verification system. This method 1600 may be performed by one or more of the systems 200-600 and 710 of FIGS. 2-7.

At operation 1610, an electronic device (such as the verification system device 721 of FIG. 7) may obtain one or more requirement sets from one or more requesters. The requirement set may correspond to insurance coverage requirements, such as insurance requirements for one or more contracts.

At operation 1620, the electronic device may enable connection between the requester and one or more insureds. For example, the electronic device may contact the insured and prompt the insured to provide information regarding one or more insurance policies. Alternatively, the electronic device may enable the requester to look up and connect to stored information corresponding to the insured and/or one or more associated insurance policies. In some implementations of such an example, the insured may have the option of approving a request to connect prior to connection. Various configurations are possible and contemplated without departing from the scope of the present disclosure.

At operation 1630, the electronic device may compare the requirement set to one or more insurance policies associated with the insured. For example, the electronic device may determine that the insurance policy or policies meet the requirements of the requirement set, are missing coverage relating to such requirements, have an authentication strength level specified by such requirements, do not have such a sufficient authentication strength level, and so on. At operation 1640, the electronic device may provide the results of the comparison and/or take one or more actions based on the comparison.

In various examples, this example method 1600 may be implemented as a group of interrelated software modules or components that perform various functions discussed herein. These software modules or components may be executed within a cloud network and/or by one or more computing devices, such as one or more components of one or more of the systems 200-600 of FIGS. 2-6 and/or the verification system device 721 of FIG. 7.

Although the example method 1600 is illustrated and described as including particular operations performed in a particular order, it is understood that this is an example. In various implementations, various orders of the same, similar, and/or different operations may be performed without departing from the scope of the present disclosure.

For example, the method 1600 is illustrated and described as enabling connection between the requester and the insured. However, it is understood that this is an example. In some implementations, the method 1600 may enable comparison of the requirement set to one or more insurance policies associated with one or more insureds without enabling any kind of connection between the requester and the insured. Various configurations are possible and contemplated without departing from the scope of the present disclosure.

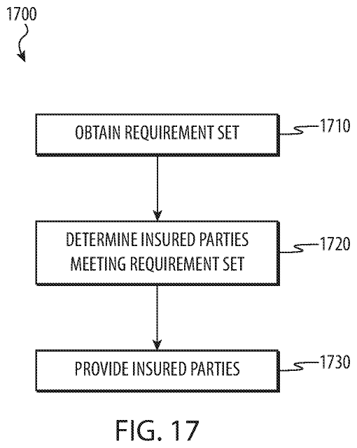

FIG. 17 depicts a flow chart illustrating a fifth example 1700 for operating an insurance verification system. This method 1700 may be performed by one or more of the systems 200-600 and 710 of FIGS. 2-7.

At operation 1710, an electronic device (such as the verification system device 721 of FIG. 7) may obtain one or more requirement sets. The requirement set may correspond to insurance coverage requirements, such as insurance requirements for one or more contracts. The electronic device may receive the requirement set from one or more requesters. Alternatively, the electronic device may determine the requirement set using information specified by the requester, such as an activity that the requester specifies (such as hiring a plumber to fix a bathroom sink) for which the electronic device determines insurance coverage requirements. Various configurations are possible and contemplated without departing from the scope of the present disclosure.

At operation 1720, the electronic device may determine one or more insured parties who meet the requirement sets. At operation 1730, the electronic device may provide the insured parties, such as by providing a list of the insured parties.

For example, homeowners may not understand the insurance coverage requirements suitable for a contractor performing an activity like installing a new roof. The homeowner may use an app executing on a mobile device to specify that the homeowner is looking to hire a roofer. The mobile device may determine insurance coverage requirements suitable for roofers, look up roofers in the homeowner's area who meet the determined insurance coverage requirements, and provide a list of such roofers to the homeowner. The homeowner may then use the list to hire one of the roofers on the list to install a new roof for the homeowner. Various configurations are possible and contemplated without departing from the scope of the present disclosure.

In various examples, insureds who are not meeting insurance requirements from searches and thus not being included in lists may be notified (and/or their insurance agent and/or insurers) of coverage that they are missing that would get them included in such lists. Various configurations are possible and contemplated without departing from the scope of the present disclosure.

In various examples, this example method 1700 may be implemented as a group of interrelated software modules or components that perform various functions discussed herein. These software modules or components may be executed within a cloud network and/or by one or more computing devices, such as one or more components of one or more of the systems 200-600 of FIGS. 2-6 and/or the verification system device 721 of FIG. 7.

Although the example method 1700 is illustrated and described as including particular operations performed in a particular order, it is understood that this is an example. In various implementations, various orders of the same, similar, and/or different operations may be performed without departing from the scope of the present disclosure.

For example, in some implementations, the operation of determining insured parties that meet the requirement sets may involve determining that the insured parties have insurance policies determined to have authentication strength levels that meet a threshold, such as at least a 3 authentication strength level on a scale of 1-5. Various configurations are possible and contemplated without departing from the scope of the present disclosure.

In various implementations, an insurance verification system may include at least one non-transitory storage medium that stores instructions and at least one processor. The at least one processor may execute the instructions to store information for at least one insurance policy in at least one block of a blockchain, determine an authentication strength level of the information according to an entity who provided the information or endorsed the information as accurate, and store an indication of the authentication strength level in association with the at least one block.

In some examples, the at least one processor may determine that the authentication strength level is a lowest authentication strength level when the entity is other than a licensed insurance agent or an insurer. In a number of examples, the at least one processor may determine that the authentication strength level is a higher authentication strength level when the entity is a licensed insurance agent unassociated with the at least one insurance policy than when the entity is other than the licensed insurance agent or an insurer. In various examples, the at least one processor may determine that the authentication strength level is a higher authentication strength level when the entity is a licensed insurance agent associated with the at least one insurance policy than when the entity is other than the licensed insurance agent associated with the at least one insurance policy or an insurer. In some examples, the at least one processor may determine that the authentication strength level is a highest authentication strength level when the entity is an insurer.

In a number of examples, the at least one processor may receive a claim associated with the at least one insurance policy and process the claim. In various such examples, the at least one processor may compare the authentication strength level to a threshold; when the authentication strength level is above the threshold, pay the claim prior to submitting the claim to an insurer associated with the at least one insurance policy for payment; and otherwise, obtain payment for the claim from the insurer prior to paying the claim.

In some implementations, an insurance verification system may include at least one non-transitory storage medium that stores instructions and at least one processor. The at least one processor may execute the instructions to determine a set of requirements associated with a requester, generate a comparison of the set of requirements to information for at least one insurance policy associated with an insured that is stored in at least one block of a blockchain, and provide results of the comparison.

In various examples, the results may indicate that the at least one insurance policy satisfies the set of requirements. In a number of examples, the results may indicate coverage required by the set of requirements that is missing from the at least one insurance policy. In some such examples, the results may be provided as a prompt to obtain the coverage.

In a number of examples, the results may indicate that an authentication strength level of the information required by the set of requirements is satisfied. In various examples, the results may prompt an entity to endorse the information as accurate in order for an authentication strength level of the information required by the set of requirements to be satisfied. In some examples, the at least one processor may determine that a change affects the results, generate an updated comparison of the set of requirements to the information, and provide results of the updated comparison.

In a number of implementations, an insurance verification system includes at least one non-transitory storage medium that stores instructions and at least one processor. The at least one processor executes the instructions to store information for at least one insurance policy associated with an insured in at least one block of a blockchain wherein the information is associated with an authentication strength level, associate the information with a set of requirements for a requester, determine a change to the information or the set of requirements, and provide a notification of the change.

In some examples, the notification may indicate that the information no longer satisfies the set of requirements. In various examples, the notification alerts an entity who endorsed the information as accurate that the information has changed. In a number of examples, the notification may prompt the insured to obtain additional insurance coverage.

In various examples, the change may correspond to a reduction in coverage associated with the at least one insurance policy. In some examples, the change may correspond to a changed beneficiary associated with the at least one insurance policy.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to a blockchain insurance verification system which may overcome these issues. The system may obtain information for one or more policies and/or updates to such policies related to one or more insureds and/or store such information in one or more blockchains. The information may detail the risk that is covered, the limits of the coverage, conditions of the coverage, endorsements and/or exclusions to the coverage, and so on. The information may also include an indication of an authentication strength level, which may correspond to the entity (such as the insured, the requester, an insurance agent, the insurer, and so on) who provided the information and/or verified the accuracy of the information. The system may be usable to store such information in an unalterable but updatable way, provide such information (which may be admissible in court and/or other proceedings due to the unalterable nature of previously stored information), connect one or more parties looking to provide and/or obtain such information, verify such information (which may be performed in real time), determine an authentication strength level of such information, determine one or more sets of requirements, compare such information to one or more sets of requirements, provide notifications (such as regarding coverage, lack of coverage, coverage to obtain, changes in coverage, coverage endorsements and/or exclusions, changes to information that an entity has verified, and so on), submit one or more claims related to the information, obtain payment and/or subrogation related to one or more submitted claims, provide the information, provide results of a comparison of the information to one or more sets of requirements, communicate with one or more systems to perform these functions, and so on.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. An insurance verification system, comprising:
at least one non-transitory storage medium that stores instructions; and
at least one processor that executes the instructions to:
store information for at least one insurance policy in at least one block of a blockchain;
determine an authentication strength level of the information according to an entity who provided the information or endorsed the information as accurate; and
store an indication of the authentication strength level in association with the at least one block.

2. The insurance verification system of claim 1, wherein the at least one processor determines that the authentication strength level is a lowest authentication strength level when the entity is other than a licensed insurance agent or an insurer.

3. The insurance verification system of claim 1, wherein the at least one processor determines that the authentication strength level is a higher authentication strength level when the entity is a licensed insurance agent unassociated with the at least one insurance policy than when the entity is other than the licensed insurance agent or an insurer.

4. The insurance verification system of claim 1, wherein the at least one processor determines that the authentication strength level is a higher authentication strength level when the entity is a licensed insurance agent associated with the at least one insurance policy than when the entity is other than the licensed insurance agent associated with the at least one insurance policy or an insurer.

5. The insurance verification system of claim 1, wherein the at least one processor determines that the authentication strength level is a highest authentication strength level when the entity is an insurer.

6. The insurance verification system of claim 1, wherein the at least one processor:
receives a claim associated with the at least one insurance policy; and
processes the claim.

7. The insurance verification system of claim 6, wherein the at least one processor:
compares the authentication strength level to a threshold;
when the authentication strength level is above the threshold, pays the claim prior to submitting the claim to an insurer associated with the at least one insurance policy for payment; and
otherwise, obtains payment for the claim from the insurer prior to paying the claim.

8. An insurance verification system, comprising:
at least one non-transitory storage medium that stores instructions; and
at least one processor that executes the instructions to:
determine a set of requirements associated with a requester;
generate a comparison of the set of requirements to information for at least one insurance policy associated with an insured that is stored in at least one block of a blockchain; and
provide results of the comparison.

9. The insurance verification system of claim 8, wherein the results indicate that the at least one insurance policy satisfies the set of requirements.

10. The insurance verification system of claim 8, wherein the results indicate coverage required by the set of requirements that is missing from the at least one insurance policy.

11. The insurance verification system of claim 10, wherein the results are provided as a prompt to obtain the coverage.

12. The insurance verification system of claim 8, wherein the results indicate that an authentication strength level of the information required by the set of requirements is satisfied.

13. The insurance verification system of claim 8, wherein the results prompt an entity to endorse the information as accurate in order for an authentication strength level of the information required by the set of requirements to be satisfied.

14. The insurance verification system of claim 8, wherein the at least one processor:
determines that a change affects the results;
generates an updated comparison of the set of requirements to the information; and
provides results of the updated comparison.

15. An insurance verification system, comprising:
at least one non-transitory storage medium that stores instructions; and
at least one processor that executes the instructions to:
store information for at least one insurance policy associated with an insured in at least one block of a blockchain;
determine an authentication strength level of the information according to an entity who provided the information or endorsed the information as accurate;
store an indication of the authentication strength level in association with the at least one block:
determine a set of requirements associated with a requester;
associate the information with the set of requirements;
generate a comparison of the set of requirements to the information;
provide results of the comparison;
determine a change to the information or the set of requirements; and
provide a notification of the change.

16. The insurance verification system of claim 15, wherein the notification indicates that the information no longer satisfies the set of requirements.

17. The insurance verification system of claim 15, wherein the notification alerts the entity who endorsed the information as accurate that the information has changed.

18. The insurance verification system of claim 15, wherein the notification prompts the insured to obtain additional insurance coverage.

19. The insurance verification system of claim 15, wherein the change corresponds to a reduction in coverage associated with the at least one insurance policy.

20. The insurance verification system of claim 15, wherein the change corresponds to a changed beneficiary associated with the at least one insurance policy.
